(19) United States
(12) Patent Application Publication
(10) Pub. No.: US 2015/0024372 A1
(43) Pub. Date: Jan. 22, 2015

(54) Sports Organizer

(71) Applicants: Stephen McHugh, Arlington, MA (US); Susan Papanek McHugh, Arlington, MA (US)

(72) Inventors: Stephen McHugh, Arlington, MA (US); Susan Papanek McHugh, Arlington, MA (US)

(21) Appl. No.: 14/333,506

(22) Filed: Jul. 16, 2014

Related U.S. Application Data
(60) Provisional application No. 61/856,049, filed on Jul. 19, 2013.

(51) Int. Cl. B43L 1/02; A63B 71/06

(52) U.S. Cl. CPC B43L 1/02; A63B 71/06
USPC 434/430

(57) ABSTRACT

The present invention is an organizer with multiple functions and the ability to use tokens to represent players in a sports setting, such as a sports field. Said organizer may include a representation of the sports field on the organizer itself. Said tokens may then be affixed to the representation of the sports field in a manner that may be strong enough to be manipulated as needed, but loose enough to move when required. The organizer further allows the user to maintain various records and documents in a convenient manner to assist the users in their coaching of athletic events. This invention may be adapted for any team oriented situation as needed.

### PRIORITY

This application claims priority to Provisional Patent Application number U.S. 61/856,049 entitled “Sports Organizer” by Stephen McHugh filed on Jul. 19, 2013. That application is incorporated by reference in its entirety.

### BACKGROUND

Youth sporting clubs exist in many communities. These range from very informal recreational clubs to organizations that elicit an almost professional league following. A major component of these clubs is the volunteer coach. Volunteer coaches tend to have several items on them at all times to assist them in their responsibilities. One item is an erasable surface to illustrate the plays to be used in a particular situation. The erasable surface uses the traditional Xs and Os drawn by the coach to differentiate between the players on the teams, but does not allow enough detail to designate each position by a player's name. While this is a good way to show in general how players are to take positions on the field, there has not been a practical way to rapidly show multiple players where they need to be at the beginning of a play in a manner that is durable and at the same time easy to follow. Any way of showing players how they are to form up on the field must be able to withstand conditions such as rapid movement and inclement weather.

Another item coaches need readily available includes basic safety information, such as first aid and other emergency information. Additionally, coaches need to keep a roster of all players. This roster contains not just player names, but also contact information for the parents, possible medical issues, or other details that coaches need available in order to make sure the players are cared for properly in an emergency.

### SUMMARY

The invention disclosed is an organizer 5 that comprises one or more token surfaces 12, 26, a clipboard surface 16, an erasable surface 14, and information surfaces 22, 24. The token surfaces 12, 26 allow personalized tokens 18 to be placed on a token surface 12, 26 to represent where players are to go on a sports field. The erasable surface 14 is used to illustrate plays to be used on the field. The clipboard surface 16 holds loose papers, while the information surfaces 22, 24 keep needed information accessible. These surfaces may collectively be referred to as operating surfaces.

It is an objective of this invention to provide a single device that gives the user access to multiple tools needed to coach an athletic team.

It is an objective of this invention to provide the user with a surface illustrating a sports field where tokens 18 can be used to designate player locations.

It is an objective of this invention to provide the user with a surface illustrating a sports field where a writing device can be used to illustrate plays.

It is an objective of this invention to provide the user with a surface displaying needed information.

It is an objective of this invention to provide the user with a location to store tokens 18 as needed.

It is an objective of this invention to provide the user with a clipboard surface 16.

It is an objective of this invention to provide the user with a mechanism to hold loose papers as needed.

It is an objective of this invention to provide the user with a means for securing a writing device to the invention.

### DETAILED DESCRIPTION FO THE DRAWINGS

In order that the manner in which the above-recited and other advantages and objectives of the invention are obtained, a more particular description of the invention briefly described above will be rendered by reference to a specific embodiment which is illustrated in the drawings. Understanding that these drawings depict only a typical embodiment of the invention are not therefore to be considered limiting in scope, the invention will be described and explained with additional specificity and detail through the use of accompanying drawings.

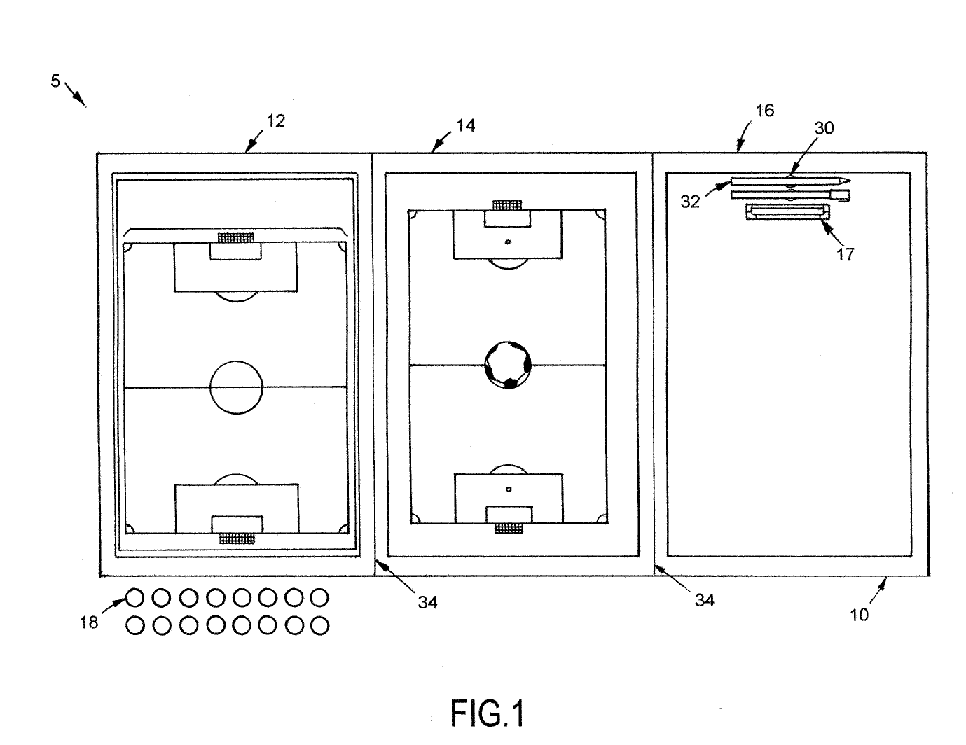

FIG. 1 shows the three outer panels of the organizer 5 in an open configuration with the tokens 18 loose and to the side.

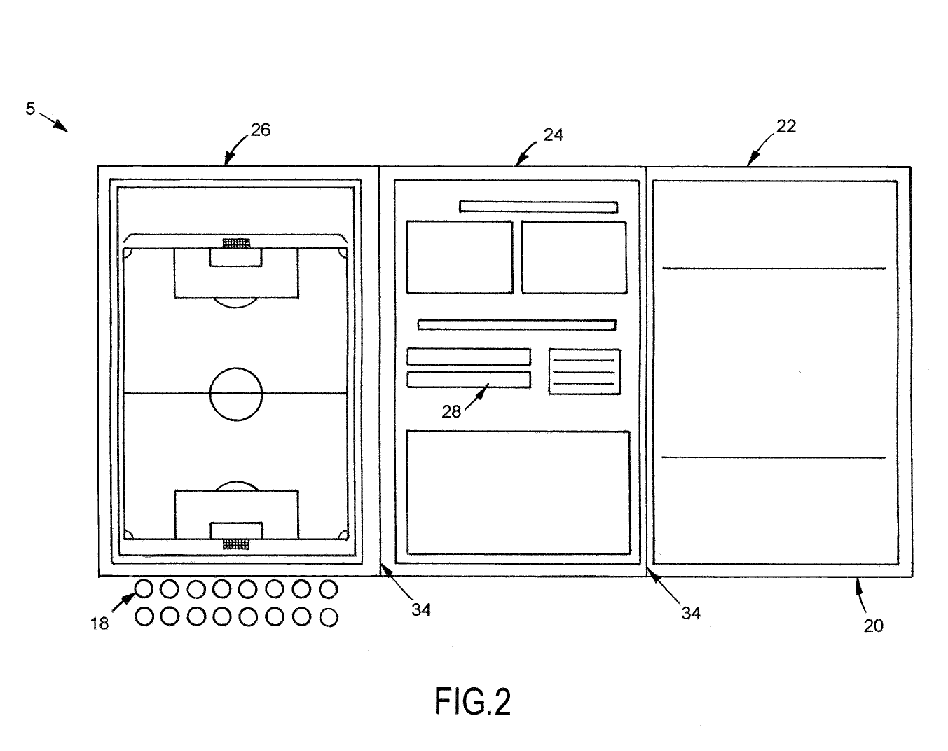

FIG. 2 shows the three inner panels of the organizer 5 in an open configuration with the tokens 18 loose and to the side.

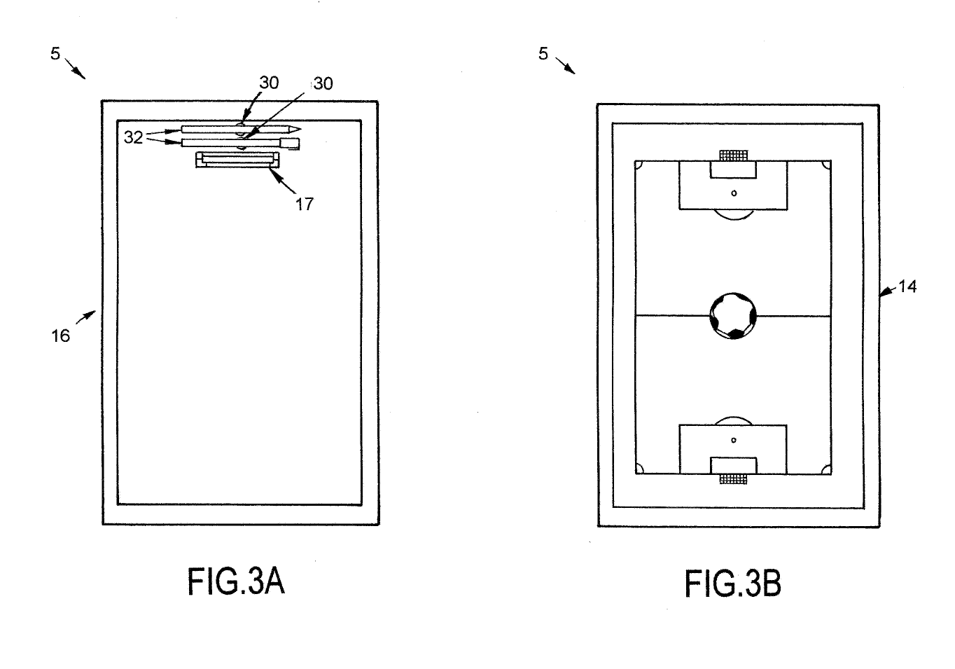

FIG. 3a shows the front cover of the organizer 5 in a closed configuration.

FIG. 3b shows the back cover of the organizer 5 in a closed configuration.

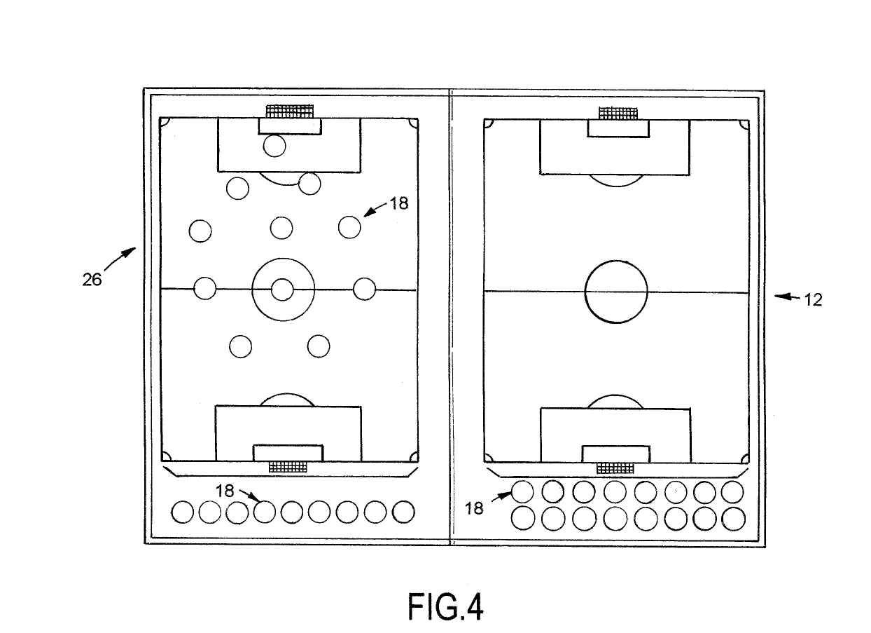

FIG. 4 shows the organizer 5 when opened to show both token surfaces 12, 26 simultaneously and tokens 18 on the token surfaces 12, 26.

### DETAILED DESCRIPTION

### Structure

In an exemplary embodiment, the foundation of the organizer 5 will be a single continuous structure with an outer surface 10 and an inner surface 20. The organizer 5 will comprise three support panels connected by hinges 34 to form the single piece, creating what is known as a “tri-fold”. The hinges 34 between the support panels may be of sufficient width to allow the surfaces to be folded into any configuration and still allow the surfaces to lay flat against each other. While the exemplary embodiment involves three support panels, the use of three support panels is not meant to be limiting, and any number of support panels may be utilized as the situation dictates. The binding of the support panels may be by any means known to those skilled in the art, including binding and gluing. In an alternative embodiment, the organizer 5 may be made from a single unit that is folded as needed to create an equivalent structure.

The organizer 5 may be constructed out of any material known to those skilled in the art which provides sufficient rigidity to accomplish the objectives of the organizer 5. The material should also allow printability and the use of fasteners, or allow such surfaces or mechanisms to be added. These materials may include, but are not limited to, paper, cardboard, textiles, and plastics.

In an exemplary embodiment, the operating surfaces 12, 14, 16, 22, 24, 26 of the organizer 5 may be mounted or created on a single panel in a manner to allow only selected operating surfaces 12, 14, 16, 22, 24, 26 to be exposed at a given time. In order to allow this versatility but keep the organizer 5 stable, magnets or other fasteners may be installed at strategic locations to keep the organizer 5 in a desired configuration until such time as the user applies enough force to release the fasteners. In an exemplary embodiment, this would allow six operating surfaces to be visible, four operating surfaces to be visible, or two operating surfaces to be visible as the configuration allowed.

In an exemplary embodiment, there is a holder mechanism 30 for holding one or more writing devices 32. Writing devices 32 could include pens, pencils, dry erase markers, grease pens, or others as needed. Writing devices 32 could be held in in place by a fastener, such as a clip, or a pouch. A pouch would allow for other items to be secured to the organizer 5 as well.

A further feature in an exemplary embodiment would include a slot in a support panel sufficient to accommodate a pad of paper by placing the support of said pad of paper into the slot to effectively couple the pad of paper to the organizer 5.

### Surfaces

For the purposes of reference, these support panels will be referred with reference to whether the panel is located on the outer surface 10 or inner surface 20. Each section will be known as section 1, section 2, and section 3 respectively. For an exemplary embodiment, there will be a total of six support panels (O1, O2, O3, I1, I2, and I3). O1 and I1 are on opposite sides of the same panel, O2 and I2 are on opposite sides of the same panel, and O3 and I3 are on opposite sides of the same panel. These support panels are shown in an open configuration in FIGS. 1 and 2. The following scheme is used:

O1—Token surface A (12)

O2—Erasable surface (14)

O3—Clipboard surface (16)

I1—Information surface A (22)

I2—Information surface B (24)

I3—Token surface B (26)

Token surface A 12 and token surface B 26 are used to help illustrate how players are to take positions on the field. The token surfaces 12, 26 comprise pictographs of the field. A set of preprinted tokens 18 with the names of all the players is available to place on the token surface 12, 26. This allows the coach to place the token 18 on the token surface 12, 26 in a manner that clearly illustrates for the players where they are supposed to go to on the field. By using fasteners, it is unlikely that the tokens 18 will move unless they are intentionally moved by the coach. In an exemplary embodiment, hook and loop fasteners are used. By having at least two token surfaces 12, 26, the coach may begin planning a new team placement on one token surface 12, 26 while not altering the current one on a different token surface 12, 26.

In an exemplary embodiment, the token surfaces 12, 26 comprise loop sided fasteners with a pictograph of the sports field screen printed on the token surface 12, 26. The tokens 18 may be stored or used on the token surface 12, 26, and coupled to the token surface 12, 26 with hook sided fasteners. While hook and loop fasteners are being used in this embodiment, it is understood that any fastener that accomplishes substantially the same purpose is also within the scope and spirit of this invention. An alternative embodiment would use magnets to accomplish substantially the same task.

The token surfaces 12, 26 may be manipulated by anyone who wants to illustrate how to position players on the field. Placement of tokens 18 can be used by coaches to explain position, and players can use tokens 18 to show their ideas to the team.

The erasable surface 14 comprises a pictograph of the sports field permanently printed on it. Such a surface may have the outline of the sports field permanently affixed to the surface, allowing the user to write on and erase marks on the erasable surface 14 without disturbing the appearance of the sports field. The erasable surface 14 may be drawn on with dry erase marker, wet erase marker, grease pencil, or by whatever way the surface of the erasable surface 14 dictates. The erasable surface 14 may also have various pieces of information, such as a web address or a computer readable code. It may also contain the logo as desired.

The clipboard surface 16 acts as a traditional clipboard. The clipboard surface 16 has a clip 17 that allows for papers or other objects to be secured to the clipboard surface 16. There may be a holder mechanism 30 to secure one or more writing device 32 to the clipboard surface 16, such as a pen, pencil, or marker. In some embodiments, the logo for the product may be placed on the clipboard surface 16 along with the logo for the particular sports club.

Information surface A 22 and information surface B 24 may be used to display commonly needed information. Examples include commonly used contact numbers, such as emergency services or the club coordinator. Other information includes first aid information for common sports injuries, such as concussions. Personal identifying information, such as the contact information of the owner, may be available to allow a binder lost during a game to be returned to the correct owner. A pocket for holding papers may be included. Papers that may be needed include, but are not limited to, team rosters and schedules, player contact information, credentials, permits, or other documents that may be needed by a coach at any given moment. The information surfaces 22, 24 may also contain token holders 28 to store tokens 18 when not in use. In the exemplary embodiment, the token holders 28 are hook and loop fastener strips.

### Tokens

The tokens 18 used by the invention go beyond the typical use of Xs and Os traditionally used in sports diagrams. The tokens 18 can have the names of each individual player for the team. Alternatively, tokens 18 may be identified by player number or any other designator determined by the user. Other embodiments may use tokens 18 with photos of the player's faces or have the names of the positions, such as CF for center forward, WM for wide midfielder, etc.

Tokens 18 are capable of adhering to the token surfaces 12, 26. The tokens 18 typically come with two layers. The bottom layer of the token 18 comprises a fastener that allows the token 18 to adhere to the token surface 12, 26. The top layer of the token 18 may be constructed of any material that allows the labeling. This includes, but is not limited to, foam, foam rubber, plastic, rubber, and cardboard. The thickness of the resulting token 18 needs to be thick enough to be durable and manipulable by both adults and children. The bottom layer and the top layer of the token 18 is fastened together by any means known to those skilled in the art. In an exemplary embodiment, they are glued together.

While some embodiments may come with tokens 18 with pregenerated labels already attached to the top surface of the token 18, such as the previously mentioned position names, there may also be embodiments where the tokens 18 come blank, and allow the user to customize the token 18 labels. In an exemplary embodiment, the tokens 18 may come with a blank surface that allows them to be written on. In another embodiment, the tokens 18 may come with a set of printer compatible labels that allows a user to print labels for the token 18 on a printer. In another embodiment, the user can affix pictures of the players to the tokens 18 to define who each token 18 represents.

### Configurations

In configuration 1, the organizer 5 is folded up with the erasable surface 14 and clipboard surface 16 exposed. In this configuration shown in FIGS. 3A and 3B, the organizer 5 may be used like a conventional clipboard, or may be flipped over to use as an erasable surface 14 to illustrate plays for the team.

In configuration 2, the organizer 5 is opened up, exposing token surface A 12 and token surface B 26 to the user as shown in FIG. 4. Token surface A 12 and token surface B 26 may now be used to show players how they are to take positions on the field by use of the individual tokens 18. One token surface 12, 26 may be for active plays, while the other token surface 12, 26 can be to experiment with various set-ups as the coach feels appropriate.

In configuration 3, the organizer 5 is further opened up, information surface A 22, information surface B 24, and token surface B 26 to the user as shown in FIG. 1. In this configuration, the token surface B 26 may still be used, but also allows the user to see various preprinted information that he may need via the information surfaces 22, 24. Also included on one of the information surfaces 22, 24 may be a pocket, clip, or other mechanism to securing loose papers to the organizer 5 as needed. Additionally, if the organizer 5 is in configuration 1 or 2, then the loose papers are further protected by the outer panels 12, 14, 16 of the organizer 5 as the papers are not exposed.

### Operations

There are multiple examples of how this organizer 5 may be operated. In one example, the coach can use a token surface 12, 26 to show exactly where he wants each player on the field. When the player take the field, the coach can rearrange the tokens 18 on token surface A 12 for the next play and arrange the tokens 18 on token surface B 26 for the following play, allowing him to plan ahead as needed. Further, the coach can allow the players to arrange their tokens 18 on either token surface 12, 26 in the event the coach wants the player to explain an idea the player may have for a play. Additionally, the erasable surface 14 can be used for a more traditional graphic representation of players were arrows are drawn as needed.

### Alternatives

In an alternate embodiment, the organizer 5 may be adapted to a traditional ringed binder. The outer covers may be the clipboard surface 16 and erasable surface 14, the inner covers as the token surfaces 12, 26, and ring bound pages for needed information.

In an alternate embodiment, the organizer 5 may be adapted to a traditional ringed binder. The inner covers may be the clipboard surface 16 and erasable surface 14, the outer covers as the token surfaces 12, 26, and ring bound pages for needed information.

In an alternate embodiment, the organizer 5 may have only two panels with a token surface 12 and an erasable surface 14.

In an alternate embodiment, the organizer 5 may have only two panels with a token surface 12 and a clipboard surface 16.

In an alternate embodiment, one of the information fields 22, 24 may be replaced with an additional erasable surface 14. In such an embodiment, it may be of a half of the sports field to allow a more detailed explanation of positioning and plays.

In an alternate embodiment, the erasable surface 14 and token surfaces 12, 26 may be set up for any different area that requires an explanation as to where people or objects need to be placed. This could be done by changing the pictographs of the sports field with a different pictograph. An example would be a theatre production.

In an alternate embodiment, the organizer 5 can be modified to allow the same functionality with other sports, including but not limited to, American football, basketball, baseball, hockey, or other team oriented sports.

A further alternate embodiment may use a computer to perform a substantial amount of the same effects described in this specification of the organizer 5. A computer could generate a display where a sports field is presented, and tokens 18 in the form of visual icons can be placed on the field (analogous to the token surfaces 12, 26) as in the previously disclosed embodiments. This may also be able to integrate the features of the token surface 12, 26 with the erasable surface 14, allowing the tokens 18 to be displayed and marks to be made with respect to the tokens 18 to show players their objectives once on the field. Further, the field could have multiple pregenerated token 18 locations, allowing a near infinite number of pregenerated token surfaces 12, 26 with preset token 18 locations to be called upon at the user's choice. The computer could also have all the needed information that the coach may need as previously discussed.

In a further alternative embodiment, the token surfaces 12, 26 may contain a magnetic component that allows a magnetic token 18 to be attached to said token surface 12, 26. In such an embodiment, the magnetic layer may be placed between two other surfaces to protect the magnetic layer.

### Conclusion

While various combinations of token surfaces 12, 26 and other possible surfaces have been mentioned in this disclosure, they are not meant to be seen in any way as limiting as different combinations of permutations of the elements disclosed in this specification fall within the scope of this inventions.

Any spatial references herein such as, for example, “top”, “bottom”, “upper”, “lower”, “above”, “below”, “rear”, “between”, “vertical”, “angular”, “beneath”, “beside”, “side”, “end”, “near”, “far”, etc. are for the purpose of illustration only and do not limit the specific orientation or location of the desired structure.

The present disclosed apparatus is well adapted to attain the ends and advantages mentioned as well as those that are inherent therein. The particular embodiments disclosed are illustrative only, as the presently disclosed apparatus may be modified and practiced in different but equivalent manners apparent to those having ordinary skill in the art and having the benefit of the teachings herein. Having described some exemplary embodiments of the presently disclosed apparatus, it is believed that various modifications are within the purview of those in the art without departing form the scope and spirit of the invention. While numerous changes may be made by those having ordinary skill in the art, such changes are encompassed within the spirit of the disclosed apparatus as disclosed above. Furthermore, no limitations are intended to the details of construction or design herein shown, other than as described. It is therefore evident that the particular exemplary embodiments disclosed above may be altered or modified and all such variations are considered within the scope and sprit of the present disclosed apparatus. The terms used have their plain, ordinary meaning unless otherwise explicitly and clearly defined by the patentee.

1. An organizer device with a plurality of surfaces for managing an activity, comprising:
at least one fastener surface, and
at least one fastener token,
wherein said at least one fastener token can be removably coupled to said at least one fastener surface.

2. The organizer device of claim 1, wherein said at least one fastener surface comprises a pictograph of a sports field.

3. The organizer device of claim 1, further comprising at least one erasable surface.

4. The organizer device of claim 3, further comprising a writing device capable of making a mark on said at least one erasable surface.

5. The organizer device of claim 3, wherein said at least one erasable surface comprises a pictograph of a sports field.

6. The organizer device of claim 1, further comprising at least one writing surface.

7. The organizer device of claim 1, further comprising at least one pocket.

8. The organizer device of claim 1, further comprising at least one clipboard surface.

9. The organizer device of claim 1, further comprising at least one information surface.

10. The organizer device of claim 1, further comprising at least one storage device for said at least one fastener token.

11. The organizer device of claim 10, wherein said at least one storage device for said at least one fastener token is a fastener strip.

12. The organizer device of claim 1, wherein said plurality of surfaces is constructed on a single piece of material that may be folded in a manner to expose less than the total number of said plurality of surfaces.

13. The organizer device of claim 1, wherein said plurality of surfaces constructed on a plurality of panels that may be folded upon each other to expose less than the total number of said plurality of surfaces.

14. The organizer device of claim 1, wherein said plurality of surfaces are formed from a single piece of material.

15. The organizer device of claim 1, wherein said plurality of surfaces are connected together to form a single continuous unit.

16. The organizer device of claim 1, wherein said at least one fastener token and said at least one fastener surface may be removably coupled by hook and loop fasteners.

17. The organizer device of claim 1, further comprising:
a second at least one fastener surface,
wherein said at least one fastener surface and said second at least one fastener
surface may be displayed at the same time.

18. A method for explaining how members of an organization are to orient themselves in a given space, comprising:
generating a visual representation of said given space,
generating a plurality of tokens corresponding to said members of an organization, and
placing said plurality of tokens on said visual representation of said given space.

19. A system for managing an activity, comprising:
an organizer device, and
at least one fastener token,
wherein said at least one fastener token may be removably coupled to said organizer device.

20. The system of claim 19, wherein said organizer device further comprises at least one fastener surface capable of detachably coupling with said at least one fastener token.
